(19) United States
(12) Patent Application Publication
(10) Pub. No.: US 2017/0360234 A1
(43) Pub. Date: Dec. 21, 2017

(54) MULTILAYER FLOOR COVERING WITH SHEET-TYPE SENSOR

(71) Applicant: TARKETT GDL, Lentzweiler (LU)

(72) Inventors: Jean-Yves Simon, Wiltz (LU); Pascal Di Croce, Wiltz (LU)

(21) Appl. No.: 15/535,283

(22) PCT Filed: Dec. 8, 2015
(86) PCT No.: PCT/EP2015/078985

§ 371 Date: Jun. 12, 2017

(30) Foreign Application Priority Data
Dec. 11, 2014 (LU) 92 610

(51) Int. Cl. A47G 27/04; B32B 37/12; B32B 7/12; B32B 27/30; E04F 15/16; E04F 15/02; G08B 21/04

(52) U.S. Cl. CPC A47G 27/0468; B32B 27/304; B32B 37/1284; E04F 15/16; B32B 7/12; B32B 2471/00; G08B 21/043; G08B 21/0461; E04F 15/0215

(57) ABSTRACT

A multilayer floor covering comprises a resilient top covering (12) for providing a walking surface, a sheet-type sensor layer (16) arranged underneath the resilient top covering, a first adhesive layer (14) attaching the resilient top covering to the sheet-type sensor layer and a second adhesive layer (18) for attaching the sheet-type sensor layer to an underlying subfloor (20). To facilitate access to the sheet-type sensor layer, the first adhesive layer (14) is configured to provide lower resistance to peeling than the second adhesive layer (18). The invention further proposes a kit of parts for achieving such a floor covering as well as a method for installing the floor covering.

### FIELD OF THE INVENTION

The invention generally relates to a multilayer floor covering to be applied as a finish material over a subfloor structure (such as e.g. screeding, concrete, a dedicated support layer or construction or any other substantially level subfloor), the multilayer floor covering including a sheet-type sensor extending underneath a resilient top covering.

### BACKGROUND OF THE INVENTION

Resilient floor coverings are typically attached to the underlying subfloor using strong adhesives which are previously spread over the surface to be covered by means of a serrated blade. This procedure guarantees high durability of the covering on the surface. When the floor covering is to be replaced, it demands efforts for the detachment and for the removal of residues of glue and/or floor covering. Physical or chemical stripping techniques may be used. Prior to laying the new floor covering, the surface may further require levelling or smoothing, depending on the damages inflicted upon it. Generally, removal of the floor covering implies its destruction or at least its degradation to an extent that it can no longer be used.

These inconveniences may be considered minor in traditional flooring, since floor coverings are typically replaced only after several years of use. Sometimes, it may be envisaged to lay new flooring on top of the old flooring, in which case a strong adhesion of the old flooring to the underlying subfloor is a prerequisite.

The above-mentioned inconveniences may become more penalising with new and future floor coverings, especially floor coverings including one or more sensing layers, which may require servicing and/or reparation interventions in time intervals shorter than the full lifetime of the floor covering. Access to the sensing layers need thus be given at less effort.

### General Description

According to an aspect of the invention, a multilayer floor covering comprises a resilient top covering for providing a walking surface, a sheet-type sensor layer arranged underneath the resilient top covering, a first adhesive layer attaching the resilient top covering to the sheet-type sensor layer and a second adhesive layer for attaching the sheet-type sensor layer to an underlying subfloor. To facilitate access to the sheet-type sensor layer, the first adhesive layer is configured to provide lower resistance to peeling than the second adhesive layer.

Thanks to the different peel resistances, the first adhesive bond is weaker than the second one and thus allows the resilient top covering above it to be peeled off the sheet-type sensor without putting at stake the attachment of the sensor layer to the underlying subfloor. It thereby becomes possible to accede the sheet-type sensor without destroying it or the top covering. It will also be appreciated that the invention allows the replacement of only the resilient top covering rather than the whole construction, thereby reducing the cost impact of purely aesthetic interventions.

In the context of the present document, the term “adhesive”, used as a noun or an adjective, designates or qualifies a substance or mixture of substances that provides a durable bond between two layers or between one layer and a substrate. A “durable bond” is a bond intended to last over the lifetime of the floor covering and which cannot be undone without its destruction. Unless explicitly indicated, the term “adhesive” thus does not encompass repositionable adhesive, which provides only a weak bond between two adjacent layers, allowing them to be separated and put together several times. The term “adhesive” may be replaced by “permanent adhesive” without departing from the above-specified meaning.

The difference in the resistance to peeling (also: “peel resistance”) may be caused (a) by the first and second adhesive layers being of different compositions, and/or (b) by the first and second adhesive layers being of different thicknesses, and/or (c) by the first and second adhesive layers being applied with different area densities (mass per unit of area), and/or (d) by the adhesive layers having undergone different pre-dry or pre-cure times, and/or (e) by different treatments of the layers being joined, and/or (f) by different chemical affinities of the adhesive layers to the layers being joined, etc.

Preferably, the resistances to peeling provided by the first and second adhesive layers, as obtained in a 90° peel strength test with an apparatus as defined in European standard EN 1372, differ by at least 50% of the greater of the two values.

The resilient top covering is preferably in conformity with European standard EN 649. The resilient top covering may comprise a natural or synthetic homogeneous or inhomogeneous floor covering with an overall thickness comprised in the range from 1 mm to 4 mm, preferably in the range from 1.5 mm to 3.5 mm and yet more preferably in the range from 2 mm to 3.5 mm. Examples of resilient top coverings usable in the context of the present invention are polyvinyl chloride (PVC) floor covering, linoleum floor covering, sheet vinyl floor covering, cork flooring and rubber floor covering. The resilient top covering may comprise a natural or synthetic inhomogeneous floor covering with a wear layer, the wear layer having a thickness of at least 0.2 mm, preferably of at least 0.5 mm.

One or both of the first and second adhesive layer may comprise a spray adhesive, e.g. water-based acrylic blend adhesive having less than 0.03 g/ml volatile organic compounds. Suitable spray adhesives are available commercially. According to a preferred embodiment of the invention, the first adhesive layer comprises a spray adhesive and the second adhesive layer comprises a serrated-blade-spread (troweled) adhesive.

An noteworthy aspect of a preferred embodiment of the present invention, in which the resilient top covering is attached to the underlying sheet-type sensor layer with spray adhesive and/or in which the sheet-type sensor layer is attached to the subfloor with spray adhesive, is that it presents smaller residual indentation than if the same layers were attached to each other by means of troweled adhesive. According to such preferred aspect of the invention, the residual indentation of the multilayer floor covering (measured in accordance with standard ISO 24343-1 after application of the specified pressure for 150 minutes and an additional rest period of 150 minutes after removal of the load) amounts to at most 0.18 mm, more preferably to at most 0.17 mm, even more preferably to at most 0.16 mm, yet more preferably to at most 0.15 mm, still more preferably to at most 0.14 mm, even still more preferably to at most 0.13 mm and most preferable to at most 0.12 mm. Lower residual indentation will be greatly appreciated in caretaking institutions, where load on rolls (e.g. bads, wheelchairs etc.) have to be moved frequently: indeed lower residual indentation translates into lower rolling drag, which facilitates the caregivers' tasks.

The sheet-type sensor layer preferably comprises one continuous pressure sensor or a plurality of pressure sensors in a two-dimensional arrangement. The pressure sensor(s) preferably providing a change of one or more electrical observables upon application of compressive force. The electrical observable(s) may, e.g., comprise impedance, resistance, capacitance, reactance, charge, current, voltage or combinations thereof. The pressure sensor(s) are transducers converting mechanical strain or deformation into an electrical observable. According to a preferred embodiment of the invention, each of the one or more pressure sensors comprises a ferroelectret polymer film sandwiched between a first electrode layer and a second electrode layer, the sheet-type sensor layer further comprising electrically insulating films, between which said the one or more pressure sensors are arranged. As used herein, the term “ferroelectret polymer film” designates a cellular polymer film structure that exhibits piezoelectric properties and, more specifically, that generates an electric potential difference between first and second electrode layers applied on its surfaces in response to the polymer film structure being compressed.

As an alternative to pressure sensors, the sheet-type sensor layer could also comprise so-called proximity sensors, which comprise one or more antenna electrodes capacitively coupling to electrically conductive bodies (e.g. humans, pets, or conductive objects) in their proximity. With proximity sensors, the electrical observables may again be impedance, resistance, capacitance, reactance, charge, current, voltage or combinations thereof.

For shielding the one or more sensors of the sheet-type sensor layer (be it pressure sensors, proximity sensors and/or other sensors) from interference, the sheet-type sensor layer preferably comprises one or more grounded, electrically conducting shield layers.

Another aspect of the present invention relates to a method of installing a multilayer floor covering. Such a method comprises:
coating a subfloor with the second adhesive layer (the numbering of the layers is only eased distinction thereof);
laying the sheet-type sensor layer on the subfloor coated with the second adhesive layer;
coating a top surface of the sheet-type sensor layer with the first adhesive layer; and
and laying a resilient top covering on the top surface of the sheet-type sensor layer so as to providing a walking surface.

During the application of the first and second adhesive layers, care is taken to configure and arrange them in such a way that the first adhesive layer attaching the resilient top covering to the sheet-type sensor layer provides lower resistance to peeling than the second adhesive layer attaching the sheet-type sensor layer to the underlying subfloor.

The different resistances to peeling of the first and second adhesive layers may be obtained by using adhesives of different compositions, and/or by applying the adhesives with different thicknesses and/or by applying the adhesives with different area densities, and/or by allowing the adhesives to pre-dry or pre-cure for different times before laying sheet-type sensor layer and the resilient top covering, respectively, and/or by dedicated treatments of the layers that are joined, and/or by a suitable choice of the materials of the layers being joined and the adhesives with regard to the chemical affinities and the resulting bonding strengths.

Yet another aspect of the present invention relates to a kit of parts for installing a multilayer floor covering. Such a kit of parts comprise the following separate components:
a resilient top covering for providing the walking surface;
a sheet-type sensor layer for being arranged underneath the resilient top covering;
one or more adhesives for applying in a first adhesive layer for attaching the resilient top covering to the sheet-type sensor layer and in a second adhesive layer for attaching the sheet-type sensor layer to an underlying subfloor;
and a support comprising a) instructions, which, when followed ascertain that the first adhesive layer provides lower resistance to peeling than the second adhesive layer, and/or b) a reference to a location where such instructions can be obtained.

The support may be paper (e.g. a user manual), cardboard (e.g. a packaging of one or more items of the kit), a CD, a DVD, a USB stick or any other information carrier. The instructions may be in any form understandable to humans, e.g. a written text, a spoken text, a video, a slide show, a song, a drawing, etc., or any combination thereof. A reference to a location where the instructions can be obtained (e.g. by download) may be an address to write to, an internet link (expressed e.g. as a QR code), etc.

### BRIEF DESCRIPTION OF THE DRAWINGS

By way of example, preferred, non-limiting embodiments of the invention will now be described in detail with reference to the accompanying drawings, in which:

FIG. 1: is a perspective illustration of a preferred embodiment of a multilayer floor covering comprising a sheet-type sensor;

FIG. 2: is a cross-section of the multilayer floor covering of FIG. 1;

FIG. 3: is an illustration of a kit of parts for installing a multilayer floor covering;

FIG. 4: is a schematic view of a room occupant monitoring system in a caretaking facility;

FIG. 5: is a schematic of a preferred embodiment of a sheet-type sensor and a sensor control unit connected thereto.

### DETAILED DESCRIPTION OF ONE OR MORE PREFERRED EMBODIMENTS

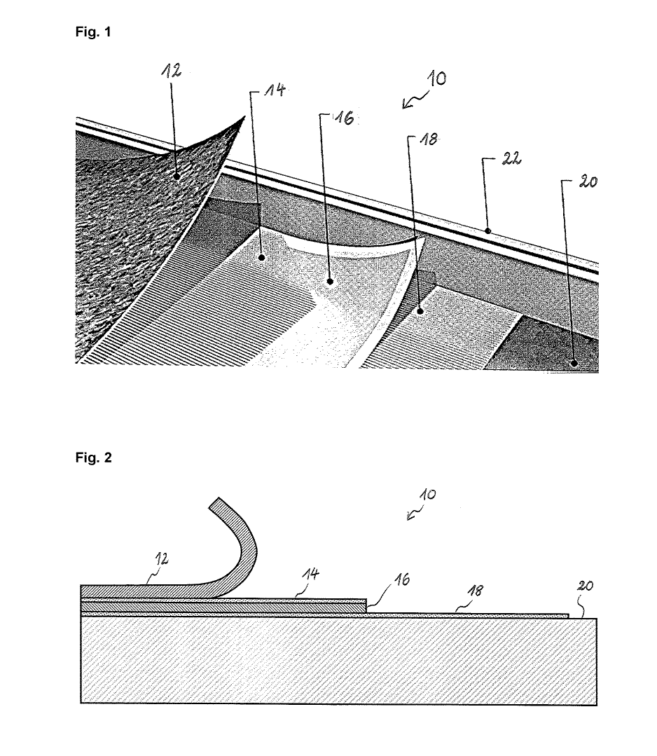

The construction of a multilayer floor covering 10 according to a preferred embodiment of the invention is best illustrated in FIGS. 1 and 2. The multilayer floor covering 10 comprises a resilient, polymer-based decorative top covering 12, a first adhesive layer 14, a sheet-type sensor 16, and a second adhesive layer 18. The sheet-type sensor is affixed to the floor pavement 20 with the second adhesive layer 18. The resilient top covering 12 is affixed on the top surface of the sheet-type sensor 16 with the first adhesive layer 14. Also shown in FIG. 1 is a skirting 22 that features LED illumination, which is controlled via the sheet-type sensor 16.

The first adhesive layer 14 is configured to provide lower resistance to peeling than the second adhesive layer 18. When the resilient top covering 12 has to be removed (be it for redecorating the room or because the sensor 16 has to be replaced or repaired), the resilient top covering 12 may be peeled off the underlying layers by firmly seizing an edge of the top covering 12 and pulling thereon.

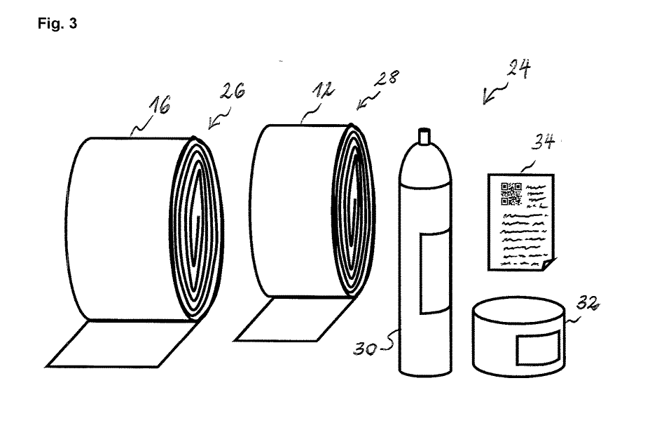

FIG. 3 illustrates a complete kit of parts 24 for installing a floor covering as illustrated in FIG. 1. The kit 24 comprises a roll 26 of the sheet-type sensor 16, a roll 28 of the decorative top covering 12, a pressurized dispenser 30 containing the first adhesive, a bucket 32 containing the second adhesive and a notice 34 with installation instructions and a QR code directing the user to a training video. The composition of the kit is meant to be illustrative only; it may vary depending on the materials of the multilayer floor covering. For instance, the top covering and/or the sheet-type sensor could take the form of tiles or planks. If the same adhesive is used for both the first and the second adhesive layer, one type of container will suffice. The notice 34 could be a loose paper notice or be applied on the packaging of one or more of the components. The instructions could also be provided on a digital information carrier (e.g. a CD, DVD or a USB stick.) It should also be noted that the quantities of the individual components in a kit may vary. Preferably, however, the composition of the kit is such that the components are provided in the right proportions.

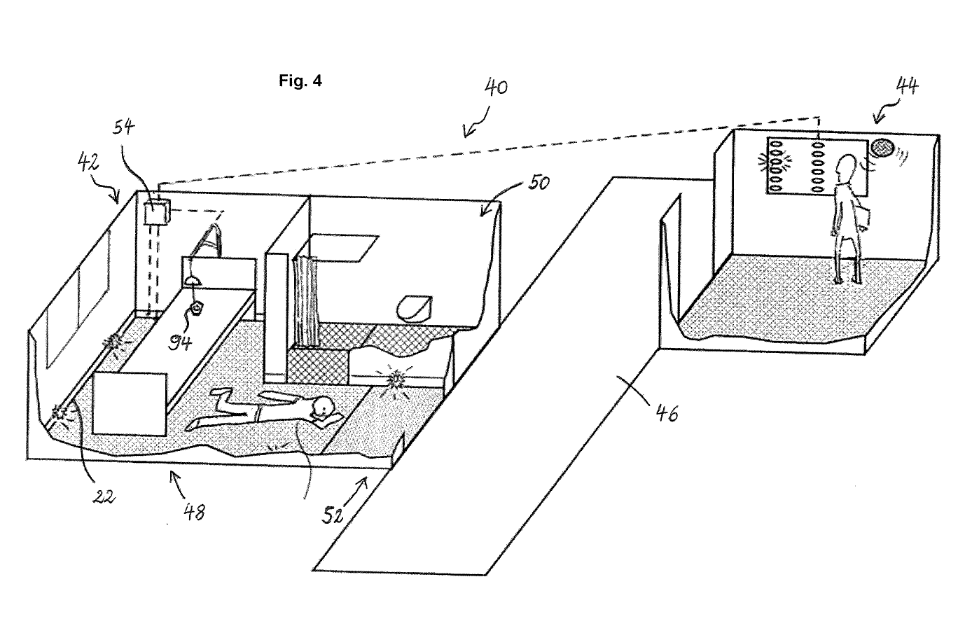

FIG. 4 schematically illustrates how a multilayer floor covering according to the invention could be used as part of a room occupant monitoring system 40 in a caretaking facility (retirement home, hospital or the like). There are shown a room 42 of a person to be monitored, a caregivers' room 44 and a hallway or corridor 46 linking those rooms. The caretaking facility may, of course, comprise further rooms but these are not shown for the sake of clarity of the drawing. The room 42 comprises a bedroom partition 48 and a bathroom partition 50. The room 42 is accessible from the hallway or corridor 46 via an entrance/exit zone 52, which is adjacent the door (not shown) of the room 42.

The room occupant monitoring system 40 comprises a multilayer floor covering 10 with a resilient polymer-based top covering having a sheet-type sensor layer arranged underneath. The construction of the multilayer floor covering 10 may be as shown in FIGS. 1 and 2.

The sheet-type sensor layer comprises plural pressure sensors arranged substantially without overlap with one another. In each zone of the room, the pressure sensors are connected in parallel to a sensor control unit 54, in such a way that the analog signals originating from different sensors within the same zone are not readily discernable by the sensor control unit 54. The sensors of a given zone are hereinafter referred to collectively as “sensor group”. The different sensor groups, each associated to a different zone of the room, are, however, connected individually to the sensor control unit 54, whereby it is known which sensor group an analog signal originates from. In the embodiment illustrated in FIG. 4, there is one sensor group for each one of the following zones: 1) entrance/exit zone 52, 2) bedroom partition 48 and 3) bathroom partition 50.

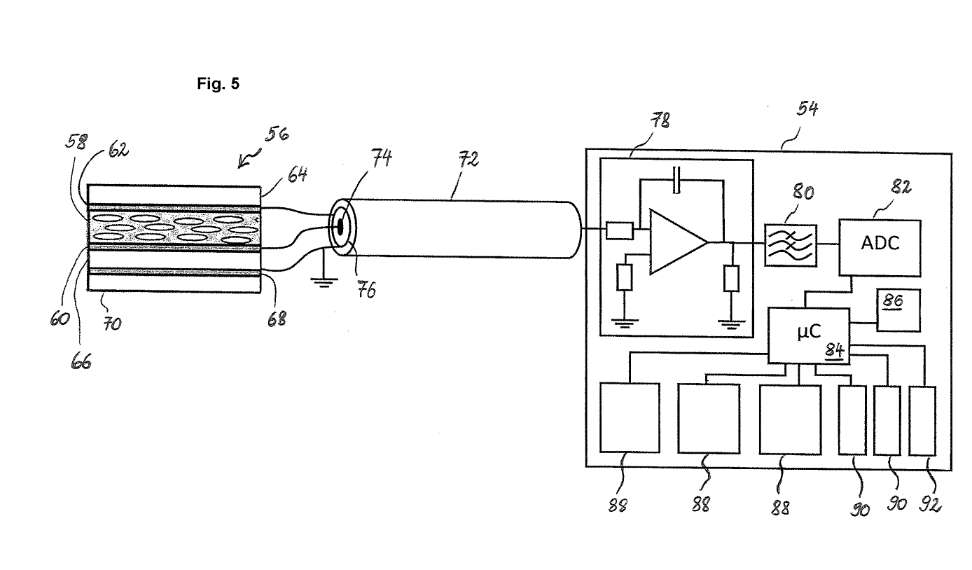

FIG. 5 schematically illustrates the sensor control unit 54 and how it is connected to one pressure sensor 56. For illustration, the pressure sensor 56 is assumed to be of the ferroelectret type. It comprises a ferroelectret polymer film 58 sandwiched between a first electrode 60 and a second electrode 62. When the ferroelectret polymer film 58 is compressed, a voltage is generated between the first and the second electrodes 60, 62. That voltage is input to the sensor control unit 54, which converts it into a digital signal for further treatment. A first electrically insulating film 64 is arranged on the second electrode 62 and a second electrically insulating film 66 is arranged between the first electrode 60 and a shield electrode 68. A third electrically insulating film 70 is applied on the opposite side of the shield electrode 68. The second electrode 62 and the shield electrode 68 are connected to ground, so as to shield the first electrode 60, which is the signal electrode of the sensor, from external electromagnetic interference. In the illustrated embodiment, the electrodes 60, 62 and 68 are aluminum layers with a thickness of 5 to 20 μm (e.g. 9 μm) each. The ferroelectret polymer film 58 has a thickness preferably comprised in the range from 50 to 100 μm (e.g. 65 μm). The electrically insulating films 64, 66, 70 can be made of PET (polyethylene terephthalate) or any other electrically insulating polymer. Their thicknesses preferably amount to 50 to 250 μm (e.g. 75 μm). The total thickness of the pressure sensor 56 thus amounts to less than 1 mm. The signal electrode (first electrode 60) may be patterned by insulating regions, which preferably extend along straight axes. Those regions allow the pressure sensor to be cut to a desired shape with a reduced risk that the cutting will cause short-circuits between the signal electrode 60 and one of the grounded electrodes 62, 68.

The pressure sensor 56 is connected to the sensor control unit 54 by a coaxial cable 72 comprising a core conductor 74 and at least one shield conductor 76 surrounding the core conductor 74. The core conductor 74 is connected to the signal electrode 60, whereas the shield conductor 76 is connected to the grounded electrodes 62, 68. The other end of the core conductor is connected to a charge amplifier 78 of the sensor control unit 54. The analog signal output by the charge amplifier 78 is filtered by a low-pass filter 80 and input to an ADC (analog-to-digital converter) 82. The digital raw signal output by the ADC 82 is processed by the microcontroller 84. The microcontroller 84 comprises or is connected to a memory module 86, in which the firmware of the sensor control unit 54 is stored. The microcontroller 84 further comprises or is connected to communication modules 88, e.g. an Ethernet, Wi-Fi, DECT (Digital Enhanced Cordless Telecommunications), GSM (Global System for Mobile Communication), GPRS (General Packet Radio Service), EDGE (Enhanced Data Rates for GSM Evolution), UMTS (Universal Mobile Telecommunications System) communications module. The microcontroller 54 also controls relays 90 allowing it to switch on and off electric devices connected to the relays 90. Finally, the sensor control unit 54 comprises a building automation system (BAS) actuator 92, via which the microcontroller 54 may be interfaced with a BAS.

Reverting to FIG. 4, the sensor control unit 54 is connected with a caregiver call system of the caretaking facility. Each room 12 is equipped with a caregiver call button 94, which is typically arranged in such a way that the room occupant can reach it from their bed. In its basic configuration, actuation of the nurse call button closes an electrical circuit, which activates an audible and visual alarm signal in the caregivers' room 44. In this case, one of the relays 90 of the sensor control unit 54 is connected in parallel to the nurse call button 94 in such a way that the microcontroller 84 can control the electrical circuit that gives the alarm. If the caretaking facility comprises a more modern nurse or caregiver call system, the sensor control system may be interfaced therewith via the BAS actuator 92 or one of the communications modules 88. When the microcontroller 84 detects a fall of the room occupant 96 (as illustrated in FIG. 4) or another event demanding a caregiver's intervention, it triggers an alarm via the caretaking facility's caregiver call system. If the caregiver call system can deal with it, an emergency code, indicating the severity of the detected event, is sent as well, in order to communicate the urgency of the need for assistance. The sensor control unit 54 is further interfaced with the LEDs integrated in the skirting 22 of the room 42. When a critical event is detected, the microcontroller 84 controls the LEDs in such a way that they generate a visual signal (e.g. blinking or flashing) that informs the room occupant that the event (e.g. the fall) has been detected and the alarm has been given. If the caregiver call system features bi-directional communication, the microcontroller 84 may also inform the room occupant 96 that the caregivers have acknowledged receipt of the alarm by emitting a second visual signal.

### EXAMPLES

The multilayer floor covering of FIGS. 1 and 2 was realised as follows. A layer of spray adhesive (purchased from Spray-Lock™) was applied (with a thickness of 200 μm) on a fibrocement panel, a sheet-type sensor layer (thickness of 1 mm) was then applied on the layer after the pre-curing time prescribed by the manufacturer. The resilient top covering (PVC-based with a thickness of 2 mm) was then attached to the sheet-type sensor layer with a spray-adhesive layer (Spray-Lock™ adhesive applied 100 μm thick). The residual indentation (measured in accordance with standard ISO 24343-1) was 0.12 mm.

For comparison, a multilayer floor covering of the same construction as above was realised except that the layer of spray adhesive between the fibrocement and the sheet-type pressure sensor layer was replaced by adhesive (Uzin KE2000S) applied with a serrated blade (area density between 200 and 250 g/m²). The measured residual indentation in this example amounted to 0.15 mm.

When the two layers of spray adhesive were replaced by troweled adhesive, the residual indentation amounted to 0.20 mm, evidencing that the use of spray adhesives contributes to reduction of the residual indentation.

While specific illustrative embodiments and examples have been described herein in detail, those skilled in the art will appreciate that various modifications and alternatives to those details could be developed in light of the overall teachings of the disclosure. Accordingly, the particular arrangements disclosed are meant to be illustrative only and not limiting as to the scope of the invention, which is to be given the full breadth of the appended claims and any and all equivalents thereof.

1. A multilayer floor covering, comprising
a resilient top covering for providing a walking surface
a sheet-type sensor layer arranged underneath the resilient top covering
a first adhesive layer attaching the resilient top covering to the sheet-type sensor layer and a second adhesive layer for attaching the sheet-type sensor layer to an underlying subfloor, the first adhesive layer providing a lower resistance to peeling than the second adhesive layer.

2. The multilayer floor covering as claimed in claim 1, wherein the resistances to peeling provided by the first and second adhesive layers, as obtained in a 90° peel strength test procedure as defined in European standard EN 1372, differ by at least 50% of the greater of the two values.

3. The multilayer floor covering as claimed in claim 1, wherein the resilient top covering comprises a natural or synthetic homogeneous or inhomogeneous floor covering with an overall thickness comprised in the range from 1 mm to 4 mm, preferably in the range from 1.5 mm to 3.5 mm and yet more preferably in the range from 2 mm to 3.5 mm.

4. The multilayer floor covering as claimed in claim 1, wherein the resilient top covering comprises a natural or synthetic inhomogeneous floor covering with wear layer, the wear layer having a thickness of at least 0.2 mm, preferably of at least 0.5 mm.

5. The multilayer floor covering as claimed in claim 1, wherein at least one of the first and second adhesive layers comprises a spray adhesive.

6. The multilayer floor covering as claimed in claim 5, wherein the first adhesive layer comprises a spray adhesive and wherein the second adhesive layer comprises a serrated-blade-troweled adhesive.

7. The multilayer floor covering as claimed in claim 5, wherein the spray adhesive comprises a water-based acrylic blend having less than 0.03 g/ml volatile organic compounds.

8. The multilayer floor covering as claimed in claim 1, wherein the sheet-type sensor layer comprises one continuous pressure sensor or a plurality of pressure sensors in a two-dimensional arrangement, said pressure sensor(s) providing a change of one or more electrical observables, such as e.g. impedance, resistance, capacitance, reactance, charge, current and/or voltage upon application of compressive force.

9. The multilayer floor covering as claimed in claim 8, wherein each of the one or more pressure sensors comprises a ferroelectret polymer film sandwiched between a first electrode layer and a second electrode layer, the sheet-type sensor layer further comprising electrically insulating films, between which the one or more pressure sensors are arranged.

10. The multilayer floor covering as claimed in claim 9, wherein the sheet-type sensor layer comprises one or more grounded, electrically conducting shield layers for shielding the one or more pressure sensors from interference.

11. A method of installing a multilayer floor covering, the method comprising:
coating a subfloor with a second adhesive layer;
laying a sheet-type sensor layer on the subfloor coated with the adhesive layer;
coating a top surface of the sheet-type sensor layer with a first adhesive layer;
laying a resilient top covering on the top surface of the sheet-type sensor layer so as to providing a walking surface;
wherein the first adhesive layer attaching the resilient top covering to the sheet-type sensor layer is configured and arranged so as to provide lower resistance to peeling than the second adhesive layer attaching the sheet-type sensor layer to the underlying subfloor.

12. The method as claimed in claim 11, wherein different resistances to peeling of the first and second adhesive layers are obtained by using adhesives of different compositions and/or by applying the adhesives with different thicknesses and/or by applying the adhesives with different area densities and/or by allowing the adhesives to pre-dry or pre-cure for different times before laying sheet-type sensor layer and the resilient top covering, respectively.

13. Kit of parts for installing a multilayer floor covering as claimed in claim 1, the kit of parts comprising:
a resilient top covering for providing a walking surface;
a sheet-type sensor layer for being arranged underneath the resilient top covering;
one or more adhesives for applying in a first adhesive layer for attaching the resilient top covering to the sheet-type sensor layer and in a second adhesive layer for attaching the sheet-type sensor layer to an underlying subfloor;
and a support comprising instructions, which, when followed ascertain that the first adhesive layer provides lower resistance to peeling than the second adhesive layer, and/or a reference to a location where such instructions can be obtained.
